(19) United States
(12) Patent Application Publication
(10) Pub. No.: US 2009/0187842 A1
(43) Pub. Date: Jul. 23, 2009

(54) Drag and Drop User Interface for Portable Electronic Devices with Touch Sensitive Screens

(75) Inventors: Peter Daniel Collins, Bracknell (GB); Nicholas J.N. Murphy, The Sands (GB)

Correspondence Address: GROOVER & Associates, BOX 802889, DALLAS, TX, 75380-2889, US

(73) Assignee: 3DLabs Inc., Ltd., Hamilton (BM)

(21) Appl. No.: 12/266,211

(22) Filed: Nov. 6, 2008

Related U.S. Application Data
(60) Provisional application No. 61/022,803, filed on Jan. 22, 2008.

(51) Int. Cl. G06F 3/048

(52) U.S. Cl. 715/769

(57) ABSTRACT

A system and methods for a novel user interface of a touch sensitive screen for pocket device. The user interface contains display items and action tabs. Display items are configured to be draggable if being dragged at substantially horizontal direction; display items are configured to be scrollable if being dragged at substantially vertical direction. Dragging and releasing a draggable item to an action tab causes a specified action or a sequence of actions being applied to the item.

### CROSS REFERENCE TO RELATED APPLICATIONS

This application claims priority from U.S. Provisional Application Ser. No. 61/022,803 filed on Jan. 22, 2008, the entirety of which is incorporated herein by reference.

### BACKGROUND

This disclosure relates to portable devices displaying draggable items. More particularly, it relates to user interfaces having draggable objects and action tabs on a touch sensitive screen of a portable device where a draggable object has multiple choices of actions by dragging it to different action tabs.

Note that the points discussed below may reflect the hindsight gained from the disclosed inventions, and are not necessarily admitted to be prior art.

Touch-screen displays have been introduced and widely used due to their intuitive interface and low cost. Computers with touch-screen displays regard the operator's fingers or a hand-held stylus as the pointing device that manipulates the touch-screen's display's surface.

Portable electronic devices frequently make use of a touch sensitive screen that can detect a finger or pointing device interacting with it. The touch screen is used to simplify the user interface of a portable device because it allows direct interaction with the object the user wishes to perform an operation on, as shown in FIG. 1.

For example, the device could present a list of music tracks and the user may select which should be played by tapping one of them. If the list is longer than can be viewed on the screen, the user may scroll the list by placing a finger on it and scrolling the screen up or down. This direct interaction with the tracks on the screen makes the device easier and quicker to work with.

This type of operation may be contrasted with an alternative interface shown in FIG. 2 that uses buttons in place of a touch screen. When the user wishes to select an item on this type of device, buttons are used to scroll a highlighted selection point to the desired track, a button is then pressed to cause the selected music to play. This may be classified as indirect interaction with the track.

Although a touch screen offers benefits to the user, it also imposes limitations. As may be recognized from the above description, the act of selecting the music track is inherently bound up with applying an action to the music track such as playing it. Because action and selection are inferred from the same event, it is not possible to apply more than one action to the track. If the user wishes to delete rather than play the track, there is no way to express that preference.

### SUMMARY

Novel systems, methods, devices and novel user interfaces of a touch sensitive screen for pocket device are disclosed.

In one embodiment, the user interface contains display items and action tabs. Display items are configured to be draggable if being moved at substantially horizontal direction; display items are configured to be scrollable if being moved at substantially vertical direction. Being draggable means that the parameters of the selected item are applied with the parameters of the new position that the item's pointer moves to and the results are displayed. Being scrollable means to allow the screen to display different items when the selected item is relocated to a new position of the screen that the screen is scrolled to.

In one embodiment, dragging and releasing a draggable item to an action tab causes a specified action or a sequence of specified actions being applied to the item.

In another embodiment, the action tabs are configured to be draggable. Dragging and releasing action tabs to a selected item causes the action to be applied to the item.

In one embodiment, display items may be dragged and stored in an action tab such as a clipboard; dragging a display item to an action tab causes a different action to be applied to the dragged item than dragging the item from the action tab.

The disclosed innovation, in various embodiments, provide one or more of at least the following advantages:
Easy to use, direct and intuitive;
Providing multiple action choices and functions for selectable display items on a pocket device user interface;
Eliminating the need of a keyboard, mouse or other user input devices;
Providing a novel, open ended, programmable electronic device for which its functions are open to further software development.
A user interface that extends the choice of actions that may be applied to an object via a touch screen interface.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 shows a user interface having a selectable list of items on the touch sensitive screen of a portable device.

FIG. 2 shows a user interface having a scrollable list of items on the touch sensitive screen with Buttons for controlling the scrolling action of a portable device.

FIG. 3 shows a user interface having a draggable list of items and action tabs on the touch sensitive screen of the device of FIG. 1.

FIG. 4 shows a user interface having images and action tabs on the touch sensitive screen of the device of FIG. 3.

FIG. 5 shows a user interface having draggable web items and action tabs on the touch sensitive screen of the device of FIG. 3.

FIG. 6 shows a user interface having a draggable list of items and a clipboard tab on the touch sensitive screen of the device of FIG. 3.

FIG. 7 shows a user interface having a draggable item in a clipboard tab to drag to a selectable list of items on the touch sensitive screen of the device of FIG. 3.

FIGS. 8, 9, and 10 show a flow chart depicting the major logical operations of the drag and drop procedure used with a portable device of FIG. 3.

### DETAILED DESCRIPTION OF SAMPLE EMBODIMENTS

The numerous innovative teachings of the present application will be described with particular reference to presently preferred embodiments (by way of example, and not of limitation).

Dragging in this disclosure includes activities associated with continuous contact with an object on the screen, and release of the contact causes specified actions being applied to the object. The status of dragging may be marked by highlighting, placing a marker or sounds or redrawing of the original object.

Being draggable is that the parameters of the selected item are copied and being applied with the parameters of the new position that the item is dragged to. Being scrollable is to allow the screen to display different items when the selected item is relocated to a new position of the screen that the screen is scrolled to.

In one preferred embodiment, the system implemented is a pocket device with a touch sensitive screen.

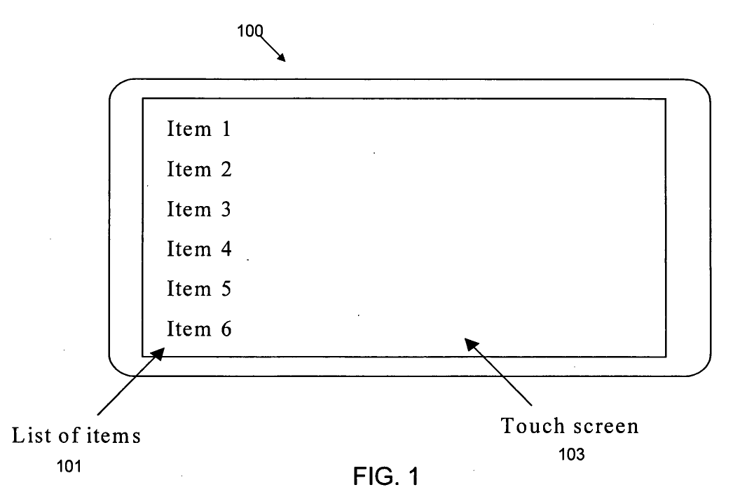

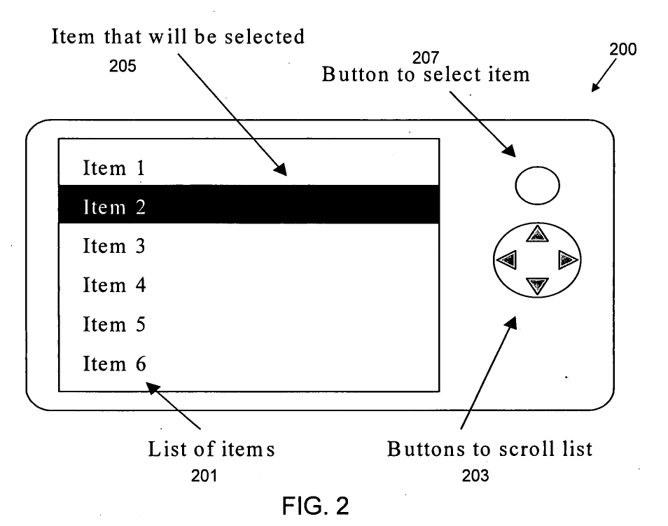

As shown in FIGS. 1 and 2, pocket devices 100 and 200 are shown to have screen 103 that is touch-sensitive (touch-screens) which functions as a display, for example, displaying list of items 101 and 201, and also acts as the pointing device surface for user input and interactions.

Devices 100 and 200 may be a PDA, cellular phone, electronic organizer, music or movie players, GPS or any other electronic devices obvious to an ordinary person skilled in the art, that have a processor or micro processor, data storage, system memory, electronic input and output and a touch sensitive screen for user interface.

Although the preferred embodiment is a pocket device, it is also contemplated and intended that this disclosure may also be applied to big screen electronics, full size computers, point of sales systems and ATMs etc.

A touch sensitive screen is sensitive to any form of input and output communications, it is not limited to physical touch; the interactions may be through radio frequency or keyboard or a mouse or a pointer that emits radio signals or through sounds.

Touch sensitive screen 103, for example, can include resistive screens that are completely pressure sensitive; capacitive screens that use a metallic coated glass panel and sense the change in current from the electricity in a finger or from a stylus wired to the computer that emits a charge; surface acoustic wave screens that use ultrasonic waves to pass over the touch screen panel. When the panel is interacted with a pointer (may or may not be physically touched), a portion of the wave is absorbed. This change in the ultrasonic waves registers the position of the touch event and sends this information to the controller for processing.

Touch screen 103 also includes an infrared touch screen panel that monitors thermal induced changes of the surface resistance or a screen consisting of an array of vertical and horizontal IR sensors that detect the interruption of a modulated light beam near the surface of the screen.

The touch screen 103 can also be produced by the other currently available technologies, for example:

Strain gauge configuration, where the screen is spring mounted on the four corners and strain gauges are used to determine deflection when the screen is touched.

Optical Imaging technology, where two or more image sensors are placed around the edges (mostly the corners) of the screen. Infrared backlights are placed in the camera's field of view on the other sides of the screen; and a touch shows up as a shadow and each pair of cameras can then be triangulated to locate the touch.

Dispersive signal technology, which uses sensors and complex algorithms to detect and interpret the mechanical energy in the glass that occurs due to a touch and to provide the actual location of the touch.

Acoustic pulse recognition which uses more than two piezoelectric transducers located at some positions of the screen to turn the mechanical energy of a touch (vibration) into an electronic signal; this signal is then converted into an audio file, and then compared to preexisting audio profile for every position on the screen.

Frustrated total internal reflection, which works by using the principle of total internal reflection to fill a refractive medium with light. When a finger or other soft object is pressed against the surface, the internal reflection light path is interrupted, making the light reflect outside of the medium and thus visible to a camera behind the medium.

Graphics tablet/screen hybrid technique, that incorporates an LCD into the input tablet allowing the user to draw directly “on” the display surface. And other technologies that is obvious to a skilled person in the art.

Touch-screen 103 is operated by contacting the screens with a pointing device, for example, a smart wireless stylus which permits wireless communication between the stylus and the device or dumb pointers such as a plastic stylus, pen, fingernail or finger tip.

Items displayed on the screen may be selected by tapping on the interested item (such as 205) or pressing the selection Button 207 as shown in FIG. 2.

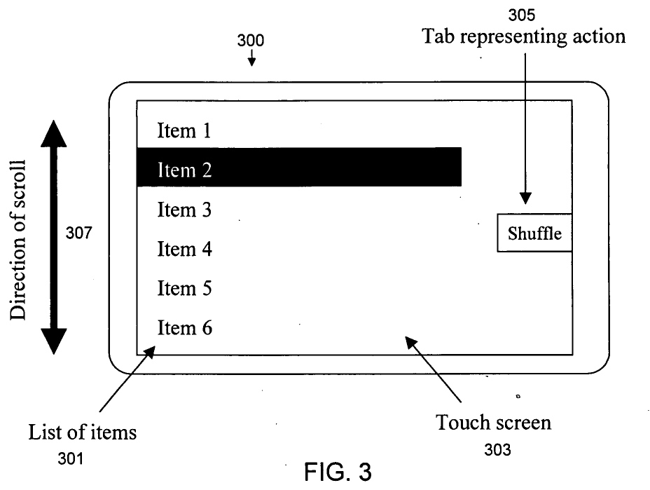

Screens may be scrolled by scrolling the screen using scrolling Button 203 in FIG. 2 or by dragging items vertically or horizontally as shown in FIG. 3.

Selected items can be dragged around the screen to other positions by continuous contact between the pointer and the screen, with the selected item dragged at the point of contact.

In one embodiment, referencing to FIG. 3, device 300 has a touch screen 303 which contains a user interface that includes one or more action tabs, such as tab 305 representing Shuffle action, displayed at the direction perpendicular to the scrolling direction of the screen, and away from the organized item list. For example, if the screen scrolls at the vertical direction such as 307, the action tabs 305 are displayed at the far end of the horizontal direction of the screen 303, away from the item list 301. If the displayed item list scrolls at the horizontal direction of the screen, the action tabs are placed at the far end of the vertical direction of the screen, such as the bottom or the top of the screen.

The action tabs represent active regions of the screen that associate with defined action commands. Releasing the selected object over a tab causes the action or sequences of actions represented by that tab to be applied to the object. In FIG. 3, 301 may represent a list of music items, and the user may play the album in order by tapping on one of the items or may play them in random, or shuffled ordered by dragging the items to the Shuffle tab 305.

Action of scrolling represents different processing action than action of dragging. Action of scrolling deletes the original drawing of the selected item on the screen and re-draws it to the new screen position; but action of dragging obtains the item parameter, and at release (drop) applies the selected item parameters to the command associated to the tab dragged to and displays the result of the command action.

In the embodiment as referenced in FIG. 3, the action of scrolling the list is distinguished from the action of dragging an item to a tab by the direction of movement of the pointing device. A substantially vertical movement represents scrolling while a substantially horizontal movement represents dragging. If an object near the top of the screen is to be dragged to a tab near the bottom of the screen, the movement may initially appear vertical. In this case the movement is interpreted as scrolling and list scrolls until the item is near enough to the tab for the movement to become horizontal and be interpreted as a drag. Hence selection and action are decoupled and the number of choices for actions can be increased.

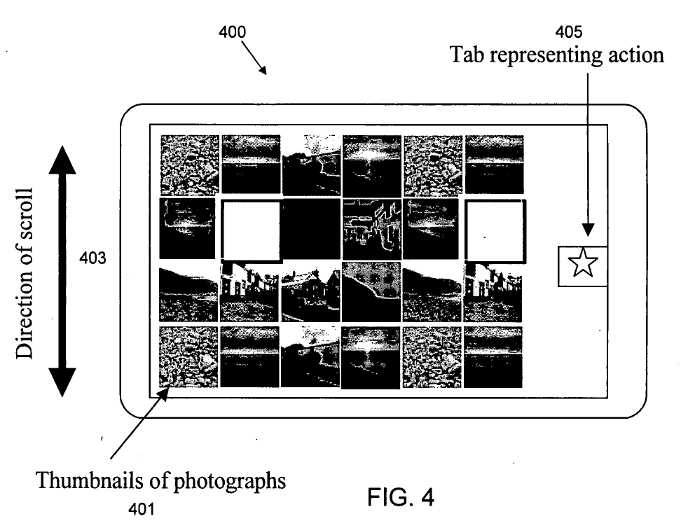

In one embodiment as referenced in FIG. 4, device 400 displays image thumbnails 401, and any of which can be tapped to open the represented photograph. Any one of the thumbnails can be dragged horizontally to action tab 405 for subsequent interaction. For example, tab 405 may represent action of choosing ‘favorite’, dragging one of the thumbnails to it causes device 400 to set the photograph as the background image for the device 400.

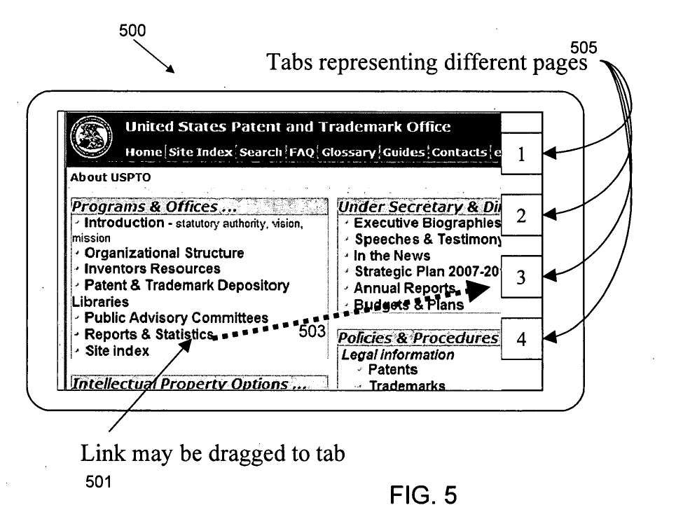

In one embodiment as referenced in FIG. 5, device 500 displays links 501 of a web browser, and multiple available browser action tabs 505. Any one of the marked links can be dragged as shown by arrow 503 to one of the tabs, each tab representing an independent action that may be triggered. For example, each one of the tabs may represent an independent search web page that may be viewed. This is particularly useful when one of the pages shows the results of a search; the action tabs allows the user to inspect different results without needing to retrace the hyperlinks to get back to the results page.

A web browser introduces additional complexity because it may need to scroll horizontally and vertically so the tabs cannot be placed orthogonal to the direction of scrolling. Instead, when a link is dragged to a tab the screen scrolls first as it normally would, but if the link is released on the tab, the page reverts to its original position as though it had not been scrolled.

Although it is usually more intuitive to drag an item to a tab, it is also possible to drag a tab to an item.

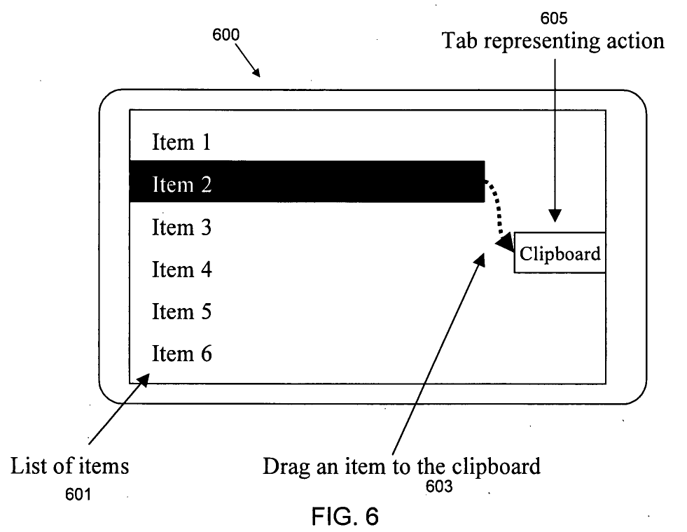

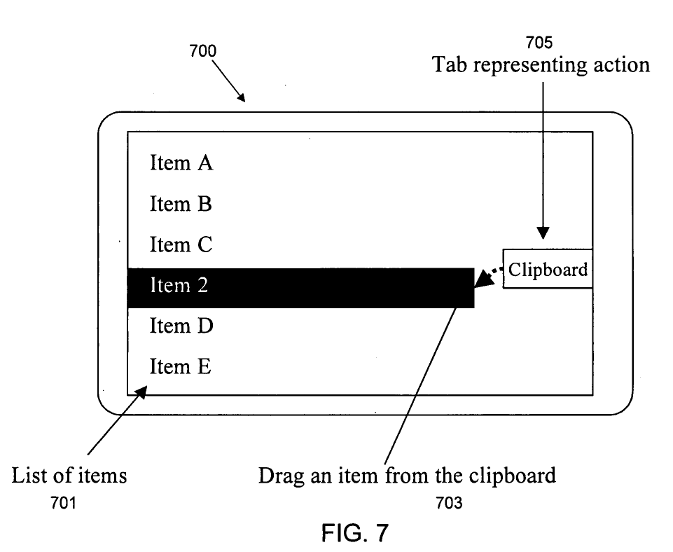

In one embodiment, referencing to FIGS. 6 and 7, in devices 600 and 700 the user interfaces display list of items 601 and 701, and action tabs 605 and 705. Tabs 605 and 705 represent a clipboard function to which an item may be dragged to and from. If the location or folder represented on the screen is then changed, the item may be dragged from the clipboard tab to its new position as shown in FIG. 7. In FIG. 6, dragging the item from the list (603) to clipboard tab 605 causes the item to be stored on the clipboard; in FIG. 7, dragging the item (703) on the clipboard tab 705 to the list 701 results in inserting the item held on clipboard into the list 701. In this embodiment, action of dragging from the tab to the list causes an action to be applied to the item that is different to the action that results from dragging the item to the tab.

Those skilled in the art will realize that it is not necessary to literally represent the dragging of an object to a tab. Other possible forms of visual confirmation of the action being taken include highlighting the object or placing a marker alongside it. Further, it will be appreciated that confirmation of the action could be audible, or non-existent.

Both software and hardware solutions can implement the novel process steps. In one embodiment, a software-based solution is provided as an extension to an operating system shell. In another embodiment, a combination hardware and software-based solution integrates the use of eye-tracking, voice recognition, or a two or three-buttoned wireless stylus.

While object identification and location selection are conventional features of a GUI operating system, an operating system shell extension is provided to enhance a typical operating system (such as Windows CE, available from Microsoft Corporation, Redmond, Calif.) to support multiple touch-screen displays.

Operating system shell extensions that support touch-screen multiple displays include:

State-saving: this will save the state information of where a pointer last touched one of the displays or upon which screen a user had just gazed; object buffer: this enables temporary storage of object parameters including its unique ID, start location on the display-may be the operating system clipboard; voice recognition for matching vocabulary with specific actions; gesture-recognition: this determines dynamic state information of the pointer/touch-screen contact including identifying and uniquely categorizing a two-dimensional touch gesture-akin to handwriting recognition.

The object parameters in the buffer are usually displayed as a virtual object for visual feedback of the state of the process. The virtual object's parameters in the buffer changes as being dragged about while the original object remains constant and anchored until the action is complete.

Facilities used for manipulation of selected object comprise both software and hardware which may include triggers to facilitate the manipulation, positioning tools to establish the paste point and releasing module for ultimately pasting the object parameters on the screen.

Computer readable medium may include any computer processor accessible electronic devices and manufactures, for example, computer hard drives, CDs, memory cards, flash cards, diskettes, tapes, virtual memory, iPod, camera, digital electronics, game kiosks, cell phones, music players, DVD players, etc.

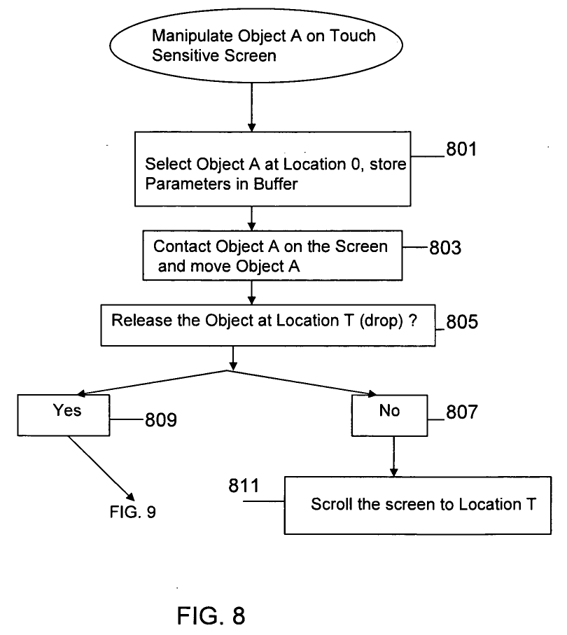

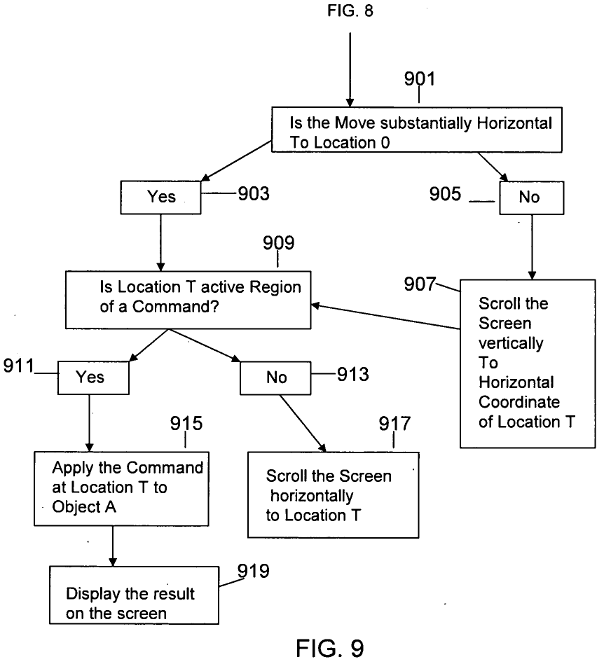

One example of the operation logic is shown in FIGS. 8 and 9. At step 801, object A, which is displayed on the screen, is selected by tapping or contacting the object for a period of time (for example 3 seconds), and the parameters of object A is obtained and stored in a memory buffer. Then Object A is continuously contacted (step 803) and moved to a new Location T of the screen (step 805). If the contact is not released (step 807), the screen scrolls (including not selected items) in accordance with the moving of the contact (step 811); if the contact is released (step 809), and if the move is not substantially horizontal to Object A's original Location 0 (step 905), the screen scrolls vertically to the horizontal coordinate of Location T (step 907), and if the Location T is an active region with a displayed action tab which embeds an action command (steps 909, 911), the horizontal move to Location T is then treated as a drag and the embedded command at Location T is applied to the parameters of Object A (step 915) and the results of the action is shown on the screen (step 919).

On the other hand, if the move is substantially horizontal to the original Location of Object A (step 903), step 909 is directly applied and if Location T has an action tab, steps 911, 915, and 919 are applied; if Location T does not have an action tab, the screen may stay or optionally continue to scroll horizontally to Location T (step 917).

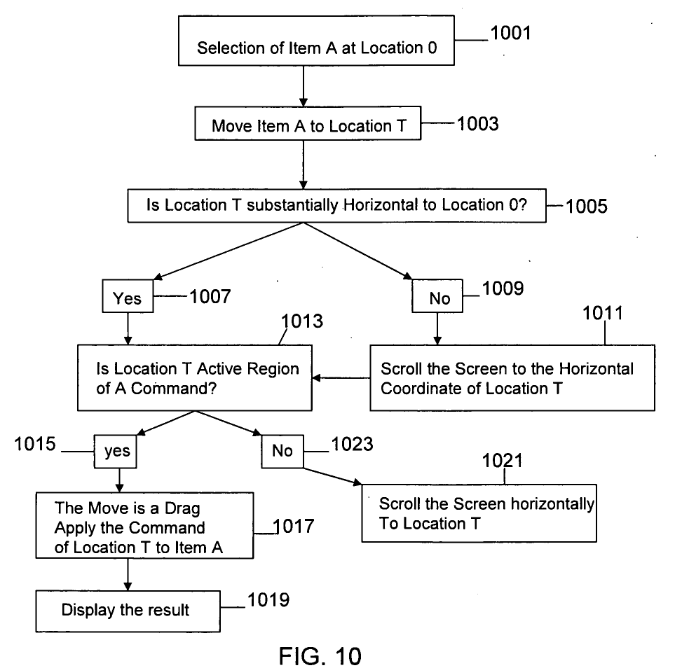

FIG. 10 shows another embodiment of the design. Item A is selected at Location 0 by tapping or continuous contacting for a period of time (step 1001). The Item A is moved to Location T by continuous contacting (step 1003). If Location T is substantially horizontal (or vertical) to Location 0 (step 1007), and if Location T embeds an action command (step 1013, 1015), the move is treated as a drag and the embedded command is applied to the parameters of Item A (step 1017), the result is displayed (step 1019). If Location T is not substantially horizontal to Location 0 (step 1009), the move is treated as a scroll and the screen is scrolled to the horizontal coordinate of Location T (step 1011), then step 1013 and subsequent steps are applied. If location T does not embed an action command, the screen may optionally continue to scroll horizontally to Location T (step 1021)

The default logic question of step 901 and step 1005 may also be set to be substantial vertical to the original location of object A in FIGS. 8, 9, or 10, or any other parameters, such as certain time period of contact, certain other direction, certain distance, certain location, certain movement of the pointer, certain contact behavior etc.

According to various embodiments, there is provided: a system interface comprising: a screen on which a cursor is user-controlled; and a plurality of objects on the screen, which are selectable and draggable by said cursor; and a plurality of action tabs on said screen; wherein, when the cursor drags one of said objects in a first direction, the plurality of objects, including unselected ones of said objects, shifts accordingly; and wherein, when the cursor drags one of said objects to one of said action tabs, an action corresponding to said one action tab is executed; whereby users can select any one of multiple actions with a single cursor motion.

According to various embodiments, there is provided: a pocket device having a user interface on a touch sensitive screen, comprising: at least one selectable and draggable object displayed on the user interface; and at least one action tab displayed on the user interface; wherein said action tab is associated with a sequence of actions; wherein dragging said draggable object to said action tab triggers the sequence of actions specified by said tab to be applied to said object and the result of which be displayed on said touch screen; and wherein said sequence of actions is any sequence of actions other than the one for “COPY” or “DELETE”.

And in one embodiment said item is draggable when said screen is contacted in first direction; and said item is scrollable when said screen is contacted in second direction. Wherein said touch sensitive screen is sensitive to a touch of human fingers. Wherein said touch sensitive screen is sensitive to a touch of a pointing device.

The device further comprising: a plurality of buttons for scrolling the screen and for selecting said item. Wherein said tab is further configured to be draggable; and an action can be triggered by dragging said tab to said item. Wherein said tab is further configured to be draggable; and an action can be triggered by dragging said tab to said item; wherein dragging to said tab represents an action different than that applied by dragging from said tab; wherein said item is an image; wherein said item is a hyperlink from a web browser; wherein said dragging is configured to be highlighting or placing a marker; and an action can be triggered by said highlighting or said placing a marker on one of said tab.

According to various embodiments, there is provided: a pocket device having a user interface, comprising: a touch sensitive screen which can display plurality of items and tabs, wherein said tabs are configured to represent varieties of actable choices for said items other than “COPY” and “DELETE”; said tabs are configured to be draggable; and an action can be triggered by dragging one of said tabs to one of said items; wherein the result of said action triggered herein is displayed on said screen while said items are also displayed on said screen; wherein said dragging are configured to be highlighting or placing a marker; and an action can be triggered by highlighting or placing a marker on one of said tabs.

The device further comprising a configurable button for configuring the ways of interaction between said items and said tabs; said configurable button is displayed on said touch sensitive screen; wherein said tabs are configured to be draggable; and an action can be triggered by dragging one of said tabs to one of said items.

According to various embodiments, there is provided: A device having a touch sensitive screen, comprising: a processing system that can be configured to display a user interface, wherein at least one draggable object is displayed in the user interface and at least one action tab is displayed in the user interface; wherein said action tab is associated with a sequence of actions; wherein dragging said draggable object to said action tab triggers the sequence of actions specified by said tab to be applied to said object and the result of which be displayed on said touch screen; wherein said sequence of actions is any sequence of actions other than the one for “COPY” or “DELETE”.

According to various embodiments, there is provided: a method of configuring a user interface on a pocket device comprising the steps of: configuring a touch sensitive screen which can display at least one item and at least one tab; configuring said tab to represent any of actable choices for said item; configuring said item to be draggable; and triggering a corresponding action as indicated by said tab when said item is dragged to said tab.

The method further comprises steps of: configuring said tab to be draggable; and triggering a corresponding action as indicated by said tab when said tab is dragged to said item; configuring said tab to be highlightable or markable; triggering a corresponding action as indicated by said tab when said tab is highlighted or marked by an action induced from said item.

According to various embodiments, there is provided: a method of causing an action in a pocket device having a touch sensitive screen, comprising: configuring a plurality of display items on the screen to be draggable; placing a plurality of action tabs on the screen in the end of the screen that is away from the displayed items; defining a different action for each of said respective action tabs; dragging first item of said items to first tab of said action tabs; and applying the specified action represented by the tab to the dragged item.

According to various embodiments, there is provided: a computer readable medium containing program instructions that configures a user interface on a touch sensitive screen as described above.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

The disclosed interface features may be implemented in any other application software, for example, a figure of a DVD movie may be dragged to a clipboard action tab or an image in a game software may be dragged to a different environment setting specified by a list of action tabs. A phone number shown on a digital phone may be dragged to a dictionary tab or dragged to quick dial tab or dragged to the URL for reverse lookup to find out the calling person's identification or to a GPS location tab to locate the calling person's current position. The screen interface may be implemented on all electronic devices, for example, on iPod, iPhone, DVD players, CD players, PDAs, digital TVs, entertainment centers, remote controls, ATMs, computers, big or small.

In one embodiment, the touching of the screen is by human fingers.

In one embodiment, the display items are thumbnail photos.

In one embodiment, the display items are musical items.

In one embodiment, the display items may be music tracks; in another embodiment, the display items may be images; in another embodiment, the display items may be hotlinks of a web page.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

1. A system interface comprising:
a screen on which a cursor is user-controlled;
a plurality of objects on the screen, which are selectable and draggable by said cursor; and
a plurality of action tabs on said screen;
wherein, when the cursor drags one of said objects in a first direction, the plurality of objects, including unselected ones of said objects, shifts accordingly; and
wherein, when the cursor drags one of said objects in a second direction to one of said action tabs, an action corresponding to said one action tab is executed;
whereby users can select any one of multiple actions with a single cursor motion.

2. A pocket device having a user interface on a touch sensitive screen, comprising:
at least one selectable and draggable object displayed on the user interface; and
at least one action tab displayed on the user interface;
wherein said action tab is associated with an action;
wherein dragging said draggable object to said action tab triggers the action specified by said tab to be applied to said object and the result be displayed.

3. The device of claim 2, wherein said item is draggable when said screen is contacted in first direction; and said item is scrollable when said screen is contacted in second direction.

4. The device of claim 2, wherein said touch sensitive screen is sensitive to a touch of human fingers.

5. The device of claim 2, wherein said touch sensitive screen is sensitive to a touch of a pointing device.

6. A device of claim 2, wherein said device further comprising:
a plurality of buttons for scrolling the screen and for selecting said item.

7. The device of claim 2, wherein said tab is further configured to be draggable; and an action can be triggered by dragging said tab to said item.

8. The device of claim 2, wherein said tab is further configured to be draggable; and an action can be triggered by dragging said tab to said item; wherein dragging towards said tab triggers an action that is different than the one triggered by dragging away from said tab.

9. The device of claim 2, wherein said item is an image.

10. The device of claim 2, wherein said item is a hyperlink from a web browser.

11. The device of claim 2, wherein said dragging is configured to be highlighting or placing a marker; and
an action can be triggered by said highlighting or said placing a marker on one of said tab.

12. The device of claim 2, wherein said dragging is configured to be acoustic.

13. The device of claim 2, wherein said action is configured to be acoustic.

14. The device of claim 2, wherein said action is configured to be a clipboard.

12.-18. (canceled)

19. A method of configuring a user interface on a pocket device comprising the steps of:
configuring a touch sensitive screen which can display at least one item and at least one tab;
displaying said tab to represent any of actable choices for said item;
displaying said item to be draggable; and
triggering a corresponding action as indicated by said tab when said item is dragged to said tab.

23. The method of claim 22, further comprises the steps of:
configuring said tab to be draggable; and
triggering a corresponding action as indicated by said tab when said tab is dragged to said item.

24. The method of claim 22, further comprises the steps of:
configuring said tab to be highlightable and/or markable;
triggering a corresponding action as indicated by said tab when said tab is highlighted or marked by an action induced from said item.

25. A computer readable medium containing program instructions that configures a user interface on a touch sensitive screen as described in claim 22.

26. A computer readable medium of claim 23 further comprises program instructions that configures a user interface on a touch sensitive screen as described in claim 23.

27-28. (canceled)
